(19) United States
(12) Patent Application Publication
(10) Pub. No.: US 2026/0175716 A1
(43) Pub. Date: Jun. 25, 2026

(54) CONNECTOR DEVICE

(71) Applicant: TOYOTA JIDOSHA KABUSHIKI KAISHA, Toyota-shi (JP)

(72) Inventors: Masaru SASAKI, Toyota-shi (JP); Hiroshi UKEGAWA, Toyota-shi (JP); Takumi YAMADA, Toyota-shi (JP)

(73) Assignee: TOYOTA JIDOSHA KABUSHIKI KAISHA, Toyota-shi (JP)

(21) Appl. No.: 19/371,447

(22) Filed: Oct. 28, 2025

(30) Foreign Application Priority Data
Dec. 19, 2024 (JP) 2024-223704

(51) Int. Cl. B60L 53/16; B60L 53/18; B60L 53/66

(52) U.S. Cl. CPC B60L 53/16; B60L 53/18; B60L 53/66

(57) ABSTRACT

In the connector device, in a state in which the charging control unit is connected to the connection portion, the charging control unit, the connection portion, the cable, and the inlet connection portion form a charging path configured to be capable of transmitting electric power to the vehicle connected to the inlet connection portion. The connection portion to which the charging control unit is not connected is configured to be electrically connectable to an external load different from the charging control unit. In a state in which the external load is electrically connected to the connection portion, the inlet connection portion, the cable, and the connection portion form a power supply path configured to be capable of transmitting power from the vehicle connected to the inlet connection portion to the external load connected to the connection portion.

### CROSS-REFERENCE TO RELATED APPLICATION

This application claims priority to Japanese Patent Application No. 2024-223704 filed on December 19, 2024. The disclosure of the above-identified application, including the specification, drawings, and claims, is incorporated by reference herein in its entirety.

### BACKGROUND

### 1. Technical Field

The present disclosure relates to a connector device.

### 2. Description of Related Art

Japanese Unexamined Patent Application Publication No. 2013-211146 (JP 2013-211146 A) discloses an external power supply connector. The external power supply connector includes an external connector body. The external connector body has a gun grip shape. The external connector body is mounted so as to be engageable with an inlet that serves as both a charging port and a discharging port of a vehicle, and enables power discharged from the vehicle side to be supplied from the inlet to an external load. The external connector body has an outlet portion to which a plug of the external load is detachably attachable.

### SUMMARY

When a connector device having a gun grip shape according to the related art is mounted to an inlet of a vehicle, an outlet portion (connection portion) of the connector device is brought relatively close to the vehicle. When the vehicle is located outdoors, for example, an external load such as an electrical appliance connected to the connection portion of the connector device tends to be exposed to external factors such as dust and water droplets. Therefore, the type of the external load that can be supplied with power from the vehicle is limited, and the convenience of the user may be reduced, depending on the location at which the vehicle is located.

The present disclosure provides a connector device that can easily protect an external load connected to a connection portion from external factors.

An aspect of the present disclosure provides a connector device including

a connector unit, and

a charging control unit.

The connector unit includes an inlet connection portion, a cable, and a connection portion.

The inlet connection portion is configured to be connectable to a vehicle.

The cable extends from the inlet connection portion.

The connection portion is provided at an end of the cable.

The charging control unit is configured to be attachable to and detachable from the connection portion.

In a connected state in which the charging control unit is connected to the connection portion, the charging control unit, the connection portion, the cable, and the inlet connection portion constitute a charging path configured to be able to transmit power to the vehicle connected to the inlet connection portion.

In the connected state, the charging control unit is configured to be able to control a current flowing through the charging path.

In the connected state, the charging control unit is configured to be able to transmit a signal relating to the current flowing through the charging path to the vehicle connected to the inlet connection portion via the connection portion, the cable, and the inlet connection portion.

The connection portion to which the charging control unit is not connected is configured to be electrically connectable to an external load different from the charging control unit.

In a state in which the external load is electrically connected to the connection portion, the inlet connection portion, the cable, and the connection portion constitute a power supply path configured to be able to transmit power from the vehicle connected to the inlet connection portion to the external load connected to the connection portion.

According to the present disclosure, an external load connected to the connection portion can be easily protected from external factors.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a connector device according to an embodiment of the present disclosure;

FIG. 2 is a diagram illustrating a configuration of a connector device and a vehicle according to an embodiment of the present disclosure;

FIG. 3 is a side view of a connection portion;

FIG. 4 shows the charging control unit as viewed from the direction in which the connection portion is connected;

FIG. 5 shows the connector unit with the charging control unit removed and an external load; and

FIG. 6 is a diagram illustrating a configuration in which a vehicle and an external load are connected to each other via a connector unit.

### DETAILED DESCRIPTION OF EMBODIMENTS

Hereinafter, a connector device according to an embodiment of the present disclosure will be described with reference to the drawings. The same or corresponding parts in the drawings are denoted by the same reference numerals, and the description thereof will not be repeated.

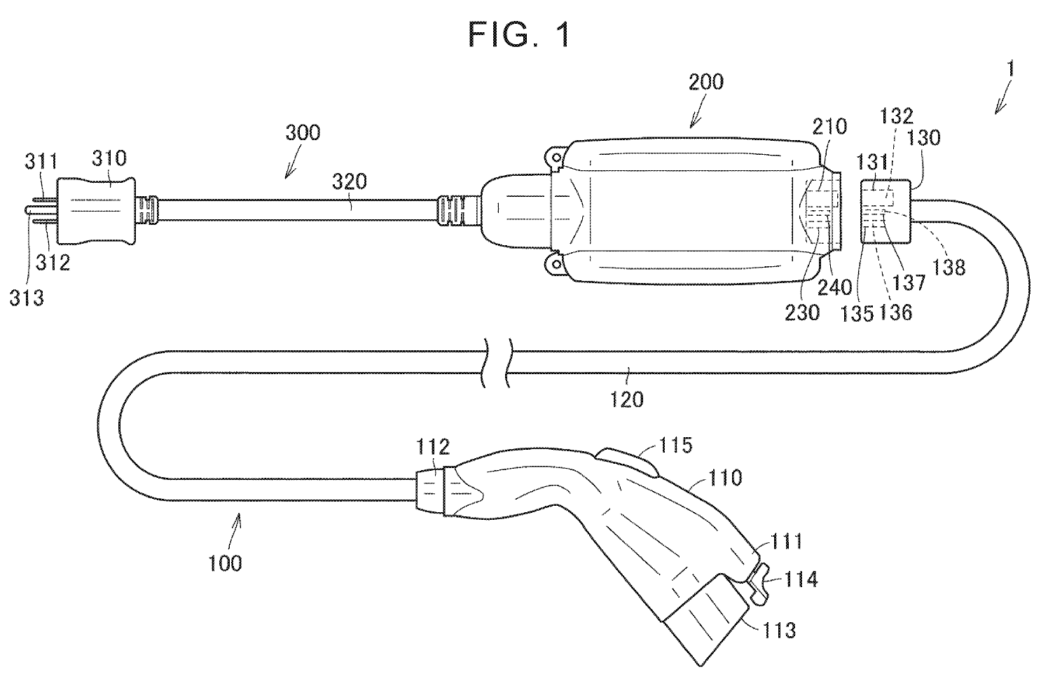

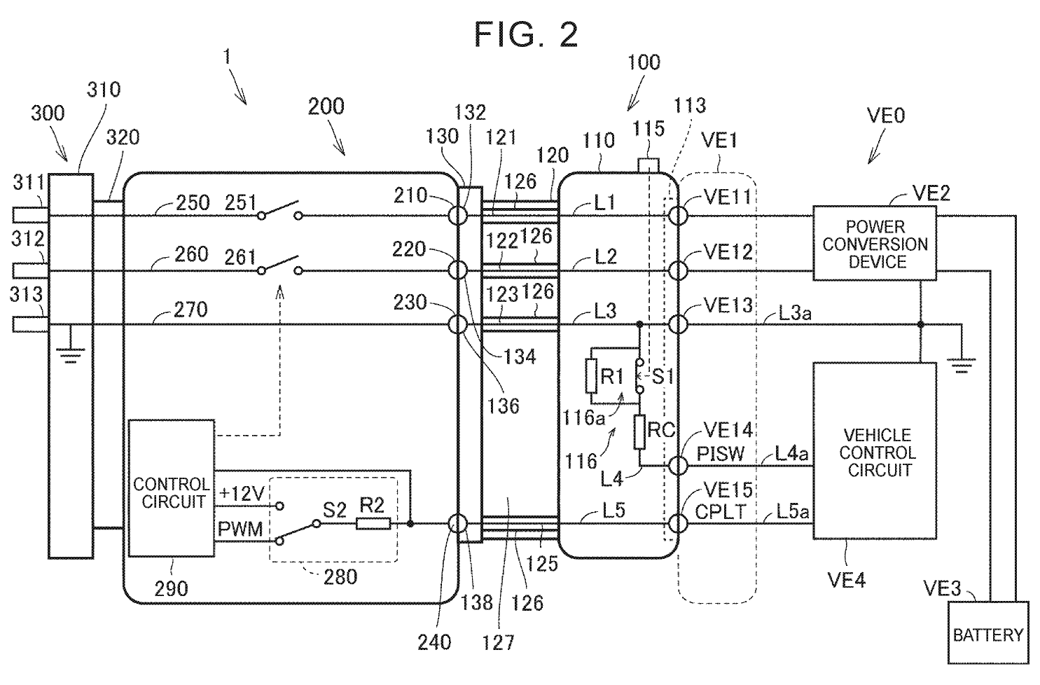

FIG. 1 is a diagram illustrating a connector device according to an embodiment of the present disclosure. FIG. 2 is a diagram illustrating a configuration of a connector device and a vehicle according to an embodiment of the present disclosure.

As shown in FIGS. 1 and 2, a connector device 1 according to an embodiment of the present disclosure may be connected to a vehicle VE0. The vehicle VE0 is, for example, a battery electric vehicle such as a plug-in hybrid battery electric vehicle (PHEV) or a battery electric vehicle (BEV).

Although the specific configuration of the vehicle VE0 is not particularly limited, the vehicle VE0 includes, for example, an inlet VE1, a power conversion device VE2, a battery VE3, and vehicle control circuit VE4.

The inlet VE1 includes two AC connection portions VE11, VE12 and three communication units VE13, VE14, VE15.

The power conversion device VE2 is electrically connected to AC connection portions VE11, VE12. The battery VE3 is electrically connected to the power conversion device VE2. The vehicle control circuit VE4 is electrically connected to each of the communication units VE13, VE14, VE15 via a communication line L3a, L4a, L5a. The communication line L3a is grounded. The vehicle control circuit VE4 is further electrically connected to the power conversion device VE2. The vehicle control circuit VE4 includes an ECU (Electronic Control Unit) (not shown).

The connector device 1 will be described. The connector device 1 includes a connector unit 100, a charging control unit 200, and an external power supply connection portion 300.

The connector unit 100 includes an inlet connection portion 110, a cable 120 (first cable), and a connection portion 130.

The inlet connection portion 110 is configured to be connectable to an inlet VE1 of the vehicle VE0. The inlet connection portion 110 has a gun grip shape. The inlet connection portion 110 includes one end 111, the other end 112, a fitting portion 113, a locking portion 114, and a user switch 115. The other end 112 is provided on the opposite side of the one end 111. Each of the fitting portion 113 and the locking portion 114 is provided at one end 111. The fitting portion 113 is configured to be able to be connected (fitted) to the inlet VE1. The locking portion 114 locks the fitting portion 113 fitted to the inlet VE1. When the user switch 115 is pressed down, the engagement between the fitting portion 113 and the inlet VE1 by the locking portion 114 is released.

The inlet connection portion 110 further includes a first wire L1, a second wire L2, a third wire L3, a fourth wire L4, and a fifth wire L5. The fourth wire L4 is branched from the third wire L3. The first wire L1, the second wire L2, the third wire L3, the fourth wire L4, and the fifth wire L5 are electrically connected to the vehicle VE0 with the fitting portion 113 fitted to the inlet VE1. When the inlet connection portion 110 is connected to the inlet VE1, the first wire L1, the second wire L2, the third wire L3, the fourth wire L4, and the fifth wire L5 are electrically connected to AC connection portion VE11, VE12 and the communication unit VE13, VE14, VE15, respectively.

The inlet connection portion 110 further includes a resistive element portion 116. The resistive element portion 116 includes a resistor R1, a resistor RC, and a switch S1. The resistor R1 and the switch S1 are connected in parallel to each other, and constitute a parallel-circuit 116a. The resistor RC is connected in series with the parallel-circuit 116a. The resistor RC is disposed between the parallel-circuit 116a and the communication unit VE14 while the inlet connection portion 110 is connected to the inlet VE1.

The switch S1 is a switch corresponding to the user switch 115. Specifically, when the user switch 115 is operated (pressed), the switch S1 is opened, and when the user switch 115 is not operated (pressed), the switch S1 is closed.

When the inlet connection portion 110 is not connected to the inlet VE1, a signal determined only by the configuration of the vehicle control circuit VE4 is generated as the connector connection signal PISW in the communication line L4a. In some cases, the inlet connection portion 110 is connected to the inlet VE1 and the user switch 115 is not operated. In such cases, a signal having a potential determined based on the configuration of the vehicle control circuit VE4 and the resistor RC is generated as the connector-connected signal PISW in the communication line L4a. In some cases, the inlet connection portion 110 is connected to the inlet VE1 and the user switch 115 is operated. In such cases, a signal having a potential determined based on the configuration of the vehicle control circuit VE4, the resistor R1, and the resistor RC is generated as the connector-connected signal PISW in the communication line L4a.

The cable 120 is a so-called cabtire cable, and has higher durability (for example, waterproofness in rainy weather) when placed outdoors as compared with a cable for household appliances provided in a normal household appliance. In addition, the cable 120 has higher durability when wound, unwound from a wound state, or pulled, and electric resistance when a current of 1A or more and 50A or less flows, as compared with a home appliance cable.

The cable 120 extends from the other end 112 of the inlet connection portion 110. The cable 120 is fixedly connected to the other end 112. The length of the cable 120 is, for example, equal to or greater than 5 m and equal to or less than 15 m.

The cable 120 includes an electric wire 121 (first electric wire), a second electric wire 122, a ground communication wire 123, a communication conductor 125, a plurality of insulators 126, and an exterior body 127.

The electric wire 121 is electrically connected to the first wire L1. The second electric wire 122 is electrically connected to the second wire L2. The ground communication wire 123 is electrically connected to the third wire L3. The communication conductor 125 is electrically connected to the fifth wire L5.

An outer diameter of each of the electric wire 121 and the second electric wire 122 may be equal to or larger than 1 mm or equal to or larger than 2 mm, and may be equal to or smaller than 5 mm or equal to or smaller than 4 mm. The plurality of insulators 126 cover the electric wire 121, the second electric wire 122, the ground communication wire 123, and the communication conductor 125, respectively. The exterior body 127 integrally further covers the plurality of insulators 126. The exterior body 127 is also referred to as a sheath. The exterior body 127 is made of, for example, polyvinyl chloride. The thickness of the exterior body 127 may be, for example, equal to or greater than 1.0 mm and equal to or less than 3.0 mm, and is preferably equal to or greater than 1.5 mm.

The connection portion 130 is provided at the end of the cable 120 on the side opposite to the inlet connection portion 110 side when viewed from the cable 120.

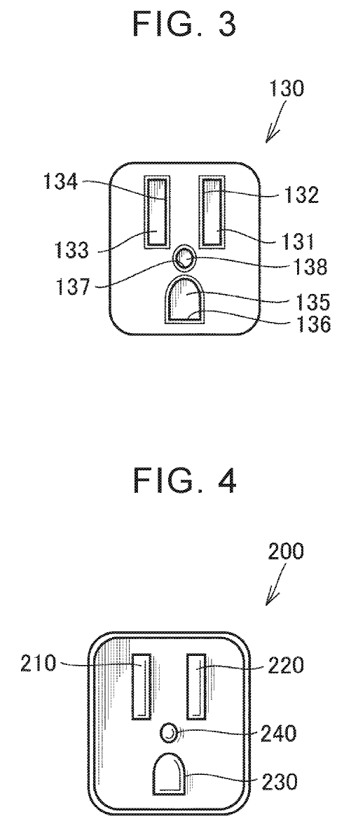

FIG. 3 is a side view of a connection portion. As shown in FIGS. 1 to 3, the connection portion 130 includes an electrical plug receptacle 131 (first electrical plug receptacle), an electrical terminal 132 (first electrical terminal), a second electrical plug receptacle 133, a second electrical terminal 134, a ground plug receptacle 135, a ground terminal 136, a communication plug receptacle 137, and a communication terminal 138. The electrical terminal 132 is provided in the electrical plug receptacle 131. The second electrical terminal 134 is provided in the second electrical plug receptacle 133. The ground terminal 136 is provided in the ground plug receptacle 135. The communication terminal 138 is provided in the communication plug receptacle 137.

The electric wire 121 is electrically connected to the electrical terminal 132. The second electric wire 122 is electrically connected to the second electrical terminal 134. The ground communication wire 123 is electrically connected to the ground terminal 136. The communication conductor 125 is electrically connected to the communication terminal 138.

The charging control unit 200 is also referred to as a CCID (Charge Circuit Interrupt Device). The charging control unit 200 is configured to be attachable to and detachable from the connection portion 130. Hereinafter, a state in which the charging control unit 200 is connected to the connection portion 130 may be referred to as a "standard connected state". That is, FIG. 1 illustrates a state in which the charging control unit 200 is separated from the connection portion 130, and FIG. 2 illustrates a standard connected state.

FIG. 4 is a view of the charging control unit viewed from a direction in which the connection portion is connected. As shown in FIGS. 1, 2, and 4, the charging control unit 200 includes an electrical plug 210 (first electrical plug), a second electrical plug 220, a ground plug 230, a communication plug 240, a voltage line 250 (first voltage line), a second voltage line 260, a ground wire 270, an oscillation circuit 280, and a control circuit 290.

The electrical plug 210 is inserted into the electrical plug receptacle 131 and contacts the electrical terminal 132 in the standard connected state. The second electrical plug 220 is inserted into the second electrical plug receptacle 133 and contacts the second electrical terminal 134 in the standard connected state. The ground plug 230 is inserted into the ground plug receptacle 135 and contacts the ground terminal 136 in the standard connected state. The communication plug 240 is inserted into the communication plug receptacle 137 and comes into contact with the communication terminal 138 in the standard connected state. The communication plug 240 is configured such that a signal is sent from the communication plug 240 to the communication terminal 138 in the standard connected state.

The voltage line 250 is electrically connected to the electrical plug 210. A relay 251 (first relay) is disposed on the voltage line 250. The second voltage line 260 is electrically connected to the second electrical plug 220. A second relay 261 is disposed on the second voltage line 260. The ground wire 270 is electrically connected to the ground plug 230.

The oscillation circuit 280 is electrically connected to the communication plug 240. The oscillation circuit 280 includes, for example, a switch S2 and a resistor R2. One end of the resistor R2 is connected to the communication plug 240. The other end of the resistor R2 is connected to the switch S2. Details of the operation of the oscillation circuit 280 will be described later.

The control circuit 290 includes, for example, a CPU (Central Processing Unit) and a memory, and controls devices (for example, the oscillation circuit 280) based on data stored in the memory. The memories include, for example, ROM (Read Only Memory) and RAM (Random Access Memory). Note that various kinds of control performed by the control circuit 290 are not limited to the processing by software, and it is also possible to construct and process dedicated hardware (electronic circuit).

The control circuit 290 includes a positive 12V power supply and an oscillator. The switch S2 is configured to conduct either one of the +12V power supply of the control circuit 290, the oscillator of the control circuit 290, and the resistor R2. Details of the operation of the control circuit 290 will be described later.

The external power supply connection portion 300 further extends from the charging control unit 200. The external power supply connection portion 300 includes an external power supply plug 310 and a second cable 320. The second cable 320 connects the charging control unit 200 and the external power supply plug 310 to each other. The external power supply plug 310 is connectable to an outlet (not shown) of an external power source. Note that the connector device 1 may not include the external power supply connection portion 300, and the charging control unit 200 may be incorporated in the external power supply.

The external power supply plug 310 includes a first external power supply terminal, a first external power supply terminal 311, a second external power supply terminal 312, and a third external power supply terminal 313. The first external power supply terminal 311, the second external power supply terminal 312, and the third external power supply terminal 313 are electrically connected to the voltage line 250, the second voltage line 260, and the ground wire 270, respectively. The third external power supply terminal 313 is grounded.

In the present embodiment, since the connector device 1 is connected to the vehicle VE0 and the external power source, the power of the external power source can be charged to the vehicle VE0. In the following description regarding charging, when there is no description regarding whether or not the connected state is the standard connected state, the connector device 1 (see FIG. 2) in the standard connected state will be described.

The external power supply connection portion 300, the charging control unit 200, the connection portion 130, the cable 120, and the inlet connection portion 110 form a charging path. The charging path is configured to be capable of transmitting power from an external power source connected to the external power supply connection portion 300 to a vehicle VE0 connected to the inlet connection portion 110.

Specifically, the first external power supply terminal 311, the voltage line 250, the electrical plug 210, the electrical terminal 132, the electric wire 121, and the first wire L1 constitute a first charging path. The second external power supply terminal 312, the second voltage line 260, the second electrical plug 220, the second electrical terminal 134, the second electric wire 122, and the second wire L2 constitute a second charging path.

The power conversion device VE2 may be supplied with AC power via the first charging path and the second charging path and AC connection portions VE11, VE12. The power conversion device VE2 converts the supplied AC power into DC power. The power conversion device VE2 charges the battery VE3 using the converted DC power.

The charging control unit 200 is configured to be able to transmit a current flowing through the charging path to the vehicle VE0 connected to the inlet connection portion 110 via the connection portion 130, the cable 120, and the inlet connection portion 110. Specifically, the communication plug 240, the communication terminal 138, the communication conductor 125, and the fifth wire L5 constitute the respective parts of the communication path. Through the communication path, the charging control unit 200 transmits a signal to the vehicle VE0.

The oscillation circuit 280 transmits the pilot-signal CPLT to the vehicle control circuit VE4. The potential of the pilot-signal CPLT is operated by the vehicle control circuit VE4. The pilot signal CPLT is used as a signal for notifying the vehicle control circuit VE4 of the rated current at the time of AC charge from the oscillation circuit 280.

The control circuit 290 detects the potential of the pilot signal CPLT outputted from the oscillation circuit 280, and controls the operation of the oscillation circuit 280 based on the detected potential of the pilot signal CPLT. In some cases, the inlet connection portion 110 is not connected to the inlet VE1, or the communication terminal 138 and the communication plug 240 are not connected to each other. In such a case, the control circuit 290 controls the switch S2 so that the positive 12V power supply and the resistor R2 become conductive. The control circuit 290 controls the operation of the oscillation circuit 280 such that the potential is V0 (e.g., +12V) and the non-oscillating pilot-signal CPLT is outputted.

In addition, the charging control unit 200 is configured to be able to control the current flowing through the charging path. Specifically, the control circuit 290 controls the opening and closing of the relay 251 and the second relay 261 based on the potential of the pilot-signal CPLT.

The vehicle control circuit VE4 transmits a signal based on the potential of the connector-connection signal PISW and the potential of the pilot-signal CPLT to the power conversion device VE2. The power conversion device VE2 starts the above-described power conversion operation based on the signal received from the vehicle control circuit VE4.

Here, in the connector device 1 according to the present embodiment, the connector unit 100 removed from the charging control unit 200 can also be used as a connector for supplying power from the vehicle VE0.

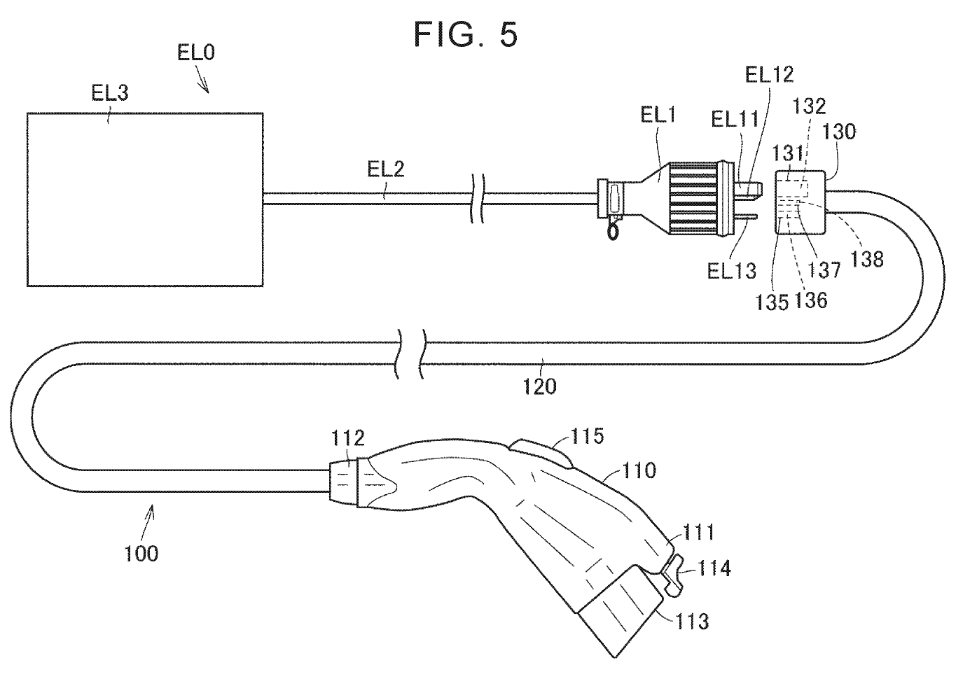

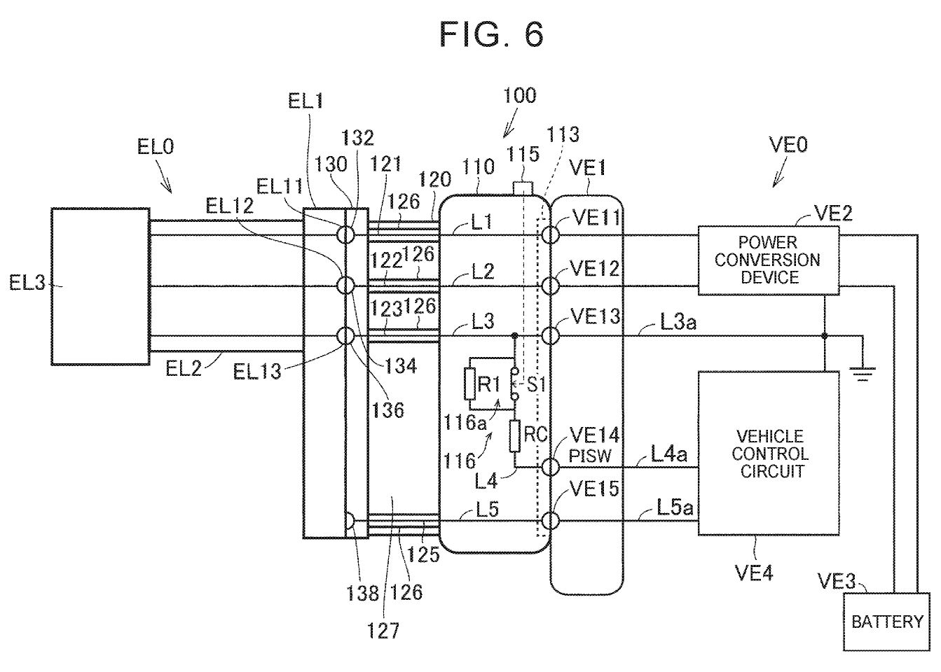

FIG. 5 is a diagram illustrating a connector unit in which the charging control unit is removed and an external load. FIG. 6 is a diagram illustrating a configuration in which a vehicle and an external load are connected to each other via a connector unit.

As illustrated in FIGS. 5 and 6, the connection portion 130 to which the charging control unit 200 is not connected is configured to be electrically connectable to an external load EL0 that differs from the charging control unit 200. The external load EL0 may be, for example, but not limited to, an appliance used by a user at home, such as a coffee-maker, an outdoor light, or a rice cooker. In the following, a load connected state in which the connector unit 100 is connected to the vehicle VE0 and the external load EL0 is electrically connected to the connection portion 130 will be described.

The external load EL0 includes a AC plug-in EL1, an external cable EL2, and an external load body EL3. The external cable EL2 connects AC plug EL1 and the external load body EL3 to each other. AC plug EL1 includes a first external electrical plug EL11, a second external electrical plug EL12, and an external grounding plug EL13.

AC plug EL1 is inserted into the electrical plug receptacle 131 and contacts the electrical terminal 132. More specifically, the first external electrical plug EL11 is inserted into the electrical plug receptacle 131 and contacts the electrical terminal 132. The second external electrical plug EL12 is inserted into the second electrical plug receptacle 133 and contacts the second electrical terminal 134. The external grounding plug EL13 is inserted into the ground plug receptacle 135 and contacts the ground terminal 136.

In the load connected state, the inlet connection portion 110, the cable 120, and the connection portion 130 form a power supply path. The power supply path is configured to be capable of transmitting power from the vehicle VE0 connected to the inlet connection portion 110 to the external load EL0 connected to the connection portion 130.

Specifically, the first wire L1, the electric wire 121, and the electrical terminal 132 constitute a first power supply path. The second wire L2, the second electric wire 122, and the second electrical terminal 134 constitute a second power supply path. The communication terminal 138 is not electrically connected to the external load EL0. In other words, in the load-connected condition, the pilot-signal CPLT does not flow to the communication line L5a.

The power conversion device VE2 converts DC power supplied from the battery VE3 into AC power. The power conversion device VE2 supplies AC power to the external load body EL3 via the first power supply path and the second power supply path, and AC plug-in EL1 and the external cable EL2.

The vehicle control circuit VE4 transmits a signal based on the potential of the connector-connected signal PISW and the fact that the pilot-signal CPLT is not received to the power conversion device VE2. The power conversion device VE2 starts the above-described power conversion operation based on the signal received from the vehicle control circuit VE4.

As described above, the connector device 1 according to the embodiment of the present disclosure includes the connector unit 100 and the charging control unit 200. The connector unit 100 includes an inlet connection portion 110, a cable 120, and a connection portion 130. The inlet connection portion 110 is configured to be connectable to a vehicle VE0. The cable 120 extends from the inlet connection portion 110. The connection portion 130 is provided at an end of the cable 120. The charging control unit 200 is configured to be attachable to and detachable from the connection portion 130. In the connected state in which the charging control unit 200 is connected to the connection portion 130, the charging control unit 200, the connection portion 130, the cable 120, and the inlet connection portion 110 form a charging path. The charging path is configured to be capable of transmitting power to the vehicle VE0 connected to the inlet connection portion 110. In the connected state, the charging control unit 200 is configured to be able to control the current flowing through the charging path. In the connected state, the charging control unit 200 is configured to transmit a current flowing through the charging path to the vehicle VE0 connected to the inlet connection portion 110 via the connection portion 130, the cable 120, and the inlet connection portion 110. The connection portion 130 to which the charging control unit 200 is not connected is configured to be electrically connectable to an external load EL0 that differs from the charging control unit 200. When the external load EL0 is electrically connected to the connection portion 130, the inlet connection portion 110, the cable 120, and the connection portion 130 form a power supply path. The power supply path is configured to be capable of transmitting power from the vehicle VE0 connected to the inlet connection portion 110 to the external load EL0 connected to the connection portion 130.

According to the above configuration, the connector device 1 used for charging the vehicle VE0 can also be used as a connector for supplying power from the vehicle VE0 to the external load EL0. The connection portion 130 to which the external loads EL0 are connected is connected to the inlet connection portion 110 via the cable 120. As a result, the degree of freedom in the arrangement location of the connection portion 130 is improved. For example, it is also possible to arrange the connection portion 130 in an environment with little external factors such as dust and water droplets. By connecting the external load EL0 to the connection portion 130 arranged in such an environment, the external load EL0 can be easily protected from external factors.

In the present embodiment, the cable 120 includes an electric wire 121, a communication conductor 125, a plurality of insulators 126, and an exterior body 127. The electric wire 121 is electrically connected to the electrical terminal 132. The communication conductor 125 is electrically connected to the communication terminal 138. The plurality of insulators 126 respectively covers the electric wire 121 and the communication conductor 125. The exterior body 127 integrally further covers the plurality of insulators 126.

According to the above configuration, a highly durable and expensive cable 120 can be diverted as a cable for power supply (for example, as compared to an external cable EL2). This improves the convenience of the user supplying the vehicle VE0.

In addition, in the present embodiment, the length of the cable 120 is equal to or greater than 5 m and equal to or less than 15 m. When the length of the cable 120 is equal to or greater than 5 m, the flexibility of the arrangement location of the connection portion 130 is further improved, and the external load EL0 connected to the connection portion 130 can be more easily protected from external factors. In addition, since the length of the cable 120 is equal to or less than 15 m, it is possible to suppree the cable 120 being difficult to handle.

In the description of the above-described embodiments, combinable configurations may be combined with each other.

The embodiments disclosed herein are to be considered in all respects as illustrative and not restrictive. It is intended that the scope of the disclosure is shown by not the above description but the claims, and includes all modifications in a meaning and scope equivalent to the claims.

What is claimed is:

1. A connector device comprising:
a connector unit; and
a charging control unit, wherein:
the connector unit includes an inlet connection portion, a cable, and a connection portion;
the inlet connection portion is configured to be connectable to a vehicle;
the cable extends from the inlet connection portion;
the connection portion is provided at an end of the cable;
the charging control unit is configured to be attachable to and detachable from the connection portion;
in a connected state in which the charging control unit is connected to the connection portion, the charging control unit, the connection portion, the cable, and the inlet connection portion constitute a charging path configured to be able to transmit power to the vehicle connected to the inlet connection portion;
in the connected state, the charging control unit is configured to be able to control a current flowing through the charging path;
in the connected state, the charging control unit is configured to be able to transmit a signal relating to the current flowing through the charging path to the vehicle connected to the inlet connection portion via the connection portion, the cable, and the inlet connection portion;
the connection portion to which the charging control unit is not connected is configured to be electrically connectable to an external load different from the charging control unit; and
in a state in which the external load is electrically connected to the connection portion, the inlet connection portion, the cable, and the connection portion constitute a power supply path configured to be able to transmit power from the vehicle connected to the inlet connection portion to the external load connected to the connection portion.

2. The connector device according to claim 1, wherein:
the connection portion includes an electrical plug receptacle, an electrical terminal, a communication plug receptacle, and a communication terminal;
the electrical terminal is provided in the electrical plug receptacle;
the communication terminal is provided in the communication plug receptacle;
the charging control unit includes an electrical plug and a communication plug;
in the connected state, the electrical plug is put into the electrical plug receptacle, is in contact with the electrical terminal, and constitutes a part of the charging path together with the electrical terminal;
in the connected state, the communication plug is put into the communication plug receptacle, is in contact with the communication terminal, and is configured such that the signal is sent from the communication plug to the communication terminal;
in a load connected state in which the external load is electrically connected to the connection portion, an alternating current (AC) plug provided in the external load is put into the electrical plug receptacle; and
in the load connected state, the electrical terminal is in contact with the AC plug and constitutes a part of the power supply path.

3. The connector device according to claim 2, wherein:
the cable includes an electric wire, a communication conductor, a plurality of insulators, and an exterior body;
the electric wire is electrically connected to the electrical terminal;
the communication conductor is electrically connected to the communication terminal;
the insulators each cover the electric wire and the communication conductor; and
the exterior body further covers the insulators integrally.

4. The connector device according to claim 3, wherein the cable has a length of 5 m or more and 15 m or less.

5. The connector device according to claim 1, wherein:
the charging control unit further includes a voltage line, an oscillation circuit, and a control circuit;
the voltage line constitutes a part of the charging path;
the voltage line includes a relay;
the oscillation circuit transmits a pilot signal as the signal; and
the control circuit controls opening and closing of the relay based on a potential of the pilot signal.
